(19) United States
(12) Patent Application Publication
(10) Pub. No.: US 2025/0333107 A1
(43) Pub. Date: Oct. 30, 2025

(54) Calibration Method of a Garden Tool, Garden Tool and Mower

(71) Applicant: Greenworks (Jiangsu) Co., Ltd, Changzhou (CN)

(72) Inventors: Wenwei Xu, Changzhou (CN); Jiafu Xue, Changzhou (CN); Yanqiang Wang, Changzhou (CN); Zhaochong Liu, Changzhou (CN); Xiazi Li, Changzhou (CN); Tao Wang, Changzhou (CN); Naixin Gao, Changzhou (CN); Zhiyuan Li, Changzhou (CN)

(21) Appl. No.: 19/264,876

(22) Filed: Jul. 10, 2025

Related U.S. Application Data
(63) Continuation of application No. PCT/CN2024/072811, filed on Jan. 17, 2024.

(30) Foreign Application Priority Data
Jan. 18, 2023 (CN) 202310067002.1
Jun. 29, 2023 (CN) 202321711252.6

(51) Int. Cl. B62D 11/00; A01D 69/02; A01D 101/00; B62D 11/04

(52) U.S. Cl. CPC B62D 11/003; A01D 69/02; B62D 11/04; A01D 2101/00

(57) ABSTRACT

A garden tool includes a control assembly, an operating mechanism, a first wheel and a second wheel. The operating mechanism is provided with a detection device for detecting a displacement of the operating mechanism. The calibration method of the disclosure includes: receiving a deviation correction command; comparing an extremum rotating speed of the first wheel with an extremum rotating speed of the second wheel; and when there is a difference between the extremum rotating speed of the first wheel and the extremum rotating speed of the second wheel, correcting a relationship between an output signal of the detection device and an output rotating speed of the control assembly to enable the extremum rotating speed of the first wheel to be the same as the extremum rotating speed of the second wheel.

### CROSS REFERENCE TO RELATED APPLICATION

The present application is a continuation application of PCT application No. PCT/CN2024/072811 filed on Jan. 17, 2024, which claims the benefit of CN202310067002.1 filed on Jan. 18, 2023, and CN202321711252.6 filed on Jun. 29, 2023. All the above are hereby incorporated by reference for all purposes.

### TECHNICAL FIELD

The disclosure relates to a field of garden tools, and in particular to a calibration method of a garden tool, a garden tool and a mower.

### BACKGROUND

At present, garden tools on the market, such as mowers, whether gasoline-powered or battery-powered, will have accuracy problems during factory debugging. Moreover, as the garden tools age, the speed regulation error caused by mechanical wear will become more serious.

### SUMMARY

The disclosure provides a calibration method of a garden tool, a garden tool and a mower to improve a deviation problem of the garden tool caused by a mechanical wear of a regulating handle.

One or more embodiments of the disclosure provide the calibration method of the garden tool. The garden tool includes a control assembly, a first wheel, a second wheel and an operating mechanism. The operating mechanism is provided with a detection device used to detect a displacement of the operating mechanism. The calibration method includes operations as follows.

A deviation correction command is received.

An extremum rotating speed of the first wheel is compared with an extremum rotating speed of the second wheel, and the extremum rotating speed of the first wheel or second wheel is a wheel rotating speed when the operating mechanism is pushed to a mechanical extremum position.

A relationship between an output signal of the detection device and an output rotating speed of the control assembly is corrected to enable the extremum rotating speed of the first wheel to be the same as the extremum rotating speed of the second wheel when there is a difference between the extremum rotating speed of the first wheel and the extremum rotating speed of the second wheel.

In an embodiment of the disclosure, the control assembly includes a first controller and a second controller, the first controller is configured to control a rotating speed of the first wheel, the second controller is configured to control a rotating speed of the second wheel, the first controller and the second controller are established in a same communication network, and the first controller and the second controller are configured to recognize output rotating speeds of each other.

In an embodiment of the disclosure, the control assembly further includes an operation panel, the deviation correction button is arranged on the operation panel, a deviation correction command is sent to the first controller and the second controller through the deviation correction button, and a manner of sending the deviation correction command includes an IO command or a communication command.

In an embodiment of the disclosure, comparing an extremum rotating speed of the first wheel with an extremum rotating speed of the second wheel includes determining whether the extremum rotating speed of the first wheel and the extremum rotating speed of the second wheel are both greater than zero. When the extremum rotating speed of the first wheel and the extremum rotating speed of the second wheel are both greater than zero, it is compared whether there is a difference between the extremum rotating speed of the first wheel and the extremum rotating speed of the second wheel.

In an embodiment of the disclosure, the garden tool includes two operating mechanisms to control the first wheel and the second wheel respectively, each operating mechanism includes an operating installation base, an operating handle and an operating rod, the operating installation base is fixedly installed on a vehicle frame of the garden tool, the operating rod is rotatably installed in the operating installation base along a first direction, and the operating handle is arranged above the operating rod and is rotatably connected with the operating rod along a second direction.

In an embodiment of the disclosure, the detection device includes an angle sensor, the angle sensor is installed on the operating rod on a corresponding side, a rotating shaft of the angle sensor rotates synchronously with the operating rod, an output voltage of the angle sensor is linearly related to an opening degree of the operating handle, and the output voltage of the angle sensor is linearly related to a corresponding wheel rotating speed output by the corresponding control assembly.

In an embodiment of the disclosure, the control assembly includes a first controller and a second controller, and the first controller is configured to control a rotating speed of the first wheel, the second controller is configured to control the rotating speed of the second wheel. A relationship between the output signal of the detection device and a corresponding wheel rotating speed output by the control assembly is corrected when there is the difference between the extremum rotating speed of the first wheel and the extremum rotating speed of the second wheel. When there is the difference between the extremum rotating speed of the first wheel and the extremum rotating speed of the second wheel, correcting a relationship between the output signal of the detection device and a corresponding wheel rotating speed output by the control assembly includes: when the extremum rotating speed of the first wheel is greater than the extremum rotating speed of the second wheel, the second controller not responding; and the first controller locking a current voltage of the angle sensor on a side of the first wheel and the extremum rotating speed of the second wheel, and a proportional relationship between the voltage of the angle sensor on the side of the first wheel and the rotating speed output by the first controller being corrected based on the current voltage of the angle sensor on the side of the first wheel and the extremum rotating speed of the second wheel, so as to keep the extremum rotating speed of the first wheel consistent with the extremum rotating speed of the second wheel. When the extremum rotating speed of the first wheel is less than the extremum rotating speed of the second wheel, the first controller does not respond, the second controller locks a current voltage of the angle sensor on a side of the second wheel and the extremum rotating speed of the first wheel, and corrects a proportional relationship between the voltage of the angle sensor on the side of the second wheel and the rotating speed output by the second controller based on the current voltage of the angle sensor on the side of the second wheel and the extremum rotating speed of the first wheel, so as to keep the extremum rotating speed of the second wheel consistent with the extremum rotating speed of the first wheel.

In an embodiment of the disclosure, the garden tool further includes a first driving motor and a second driving motor, the first driving motor is configured to drive the first wheel to rotate and is electrically connected with the first controller, the second driving motor is configured to drive the second wheel to rotate and is electrically connected with the second controller.

In an embodiment of the disclosure, the operating mechanism further includes a reset assembly. The reset assembly includes a spring base and a compression spring arranged in the spring base, the spring base is mounted at a bottom of the operating installation base, a first end of the compression spring is connected with the spring base, a second end of the compression spring is connected with the operating rod, and two sides of the operating rod are respectively provided with a first protrusion matched with the compression spring.

In an embodiment of the disclosure, the operating mechanism further includes a damper assembly, an end of the damper assembly is connected with a bottom of the operating rod, and a second end of the damper assembly is connected with the vehicle frame.

In an embodiment of the disclosure, the operating mechanism further includes a limiting plate, the limiting plate is arranged on the operating installation base and is provided with a limiting hole on the limiting plate that matches a rotation of the operating handle.

In an embodiment of the disclosure, the limiting hole includes a first orientation hole and a second orientation hole, the first orientation hole is adapted to a rotating amplitude of the operating handle in the first direction, the second orientation hole is communicated with the first orientation hole, and the second orientation hole is adapted to a rotating amplitude of the operating handle in the second direction.

One or more embodiments of the disclosure further provide a garden tool. The garden tool includes a first wheel, a second wheel, an operating mechanism and a control assembly. The first wheel and the second wheel are respectively arranged at two side of the vehicle frame of the garden tool. The operating mechanism is used to adjust the rotating speeds and/or steerings of the first wheel and the second wheel, and provided with a detection device to detect a displacement of the operating mechanism, and the detection device is electrically connected with the control assembly. The control assembly is configured to receive a deviation correction command, and automatically compares the extremum rotating speed of the first wheel with the extremum rotating speed of the second wheel when the garden tool is calibrated for a deviation correction. Wherein, the extremum rotating speed of the first wheel or second wheel is the wheel rotating speed when the operating mechanism is pushed to a mechanical extremum position. The relationship between an output signal of the detection device and the output rotating speed of the corresponding wheel of the control assembly is corrected to enable the extremum rotating speed of the first wheel to be the same as the extremum rotating speed of the second wheel when there is the difference between the extremum rotating speed of the first wheel and the extremum rotating speed of the second wheel.

In an embodiment of the disclosure, the control assembly includes a first controller and a second controller, the first controller is configured to control a driving device of the first wheel, the second controller is configured to control a driving device of the second wheel, the first controller and the second controller are established in a same communication network, and the first controller and the second controller are configured to recognize output rotating speeds of each other.

Considering a sealing problem of conventional garden tools, another embodiment of the disclosure further provides a garden tool. The garden tool is driven by the first wheel and the second wheel through corresponding driving motors and reducers respectively, and a sealing structure is arranged at a connection position between the driving motors and the reducers to realize a sealing along a circumferential surface and/or a radial surface of the connection, so as to solve a technical problem that in the garden tool of the prior art, there is a gap between the motor and the reducer, and foreign matter and impurities are easy to enter in a harsh environment, which may cause the reducer to fail.

In an embodiment of the disclosure, the sealing structure includes a first sealing component, and the first sealing component is coaxially sleeved on the driving motor and/or the reducer.

In an embodiment of the disclosure, the first sealing component is a first sealing ring, and the first sealing ring is provided with a first elastic structure. The first elastic structure is arranged on one surface of the first sealing ring facing the reducer along the circumferential direction, and the first elastic structure is abutted against an end face of the reducer in an interference fit, and forms a sealing with the end face through a friction matching.

In an embodiment of the disclosure, the sealing structure further includes a second sealing component, the second sealing component is coaxially arranged on the reducer, and a radial plane of the second sealing component at a connection position is arranged relative to the first sealing component.

In an embodiment of the disclosure, the first sealing component is a second sealing ring, and the second sealing ring is provided with a second elastic structure along an outer edge along the circumferential direction. the second sealing component is provided with a lip edge along the circumferential direction, the lip edge is located at the circumferential outward side of the second sealing ring, and the second elastic structure is abutted against an inner wall of the lip edge along the circumferential direction in an interference fit, and is matched with the lip edge to form a seal through a friction matching.

In an embodiment of the disclosure, the first sealing component is provided with a first deck surface, the second sealing component is provided with a second deck surface, the first deck surface and the second deck surface are arranged relative to each other at the radial plane, a gap is left between the first deck surface and the second deck surface, and a distance of the gap is from 1 mm to 3 mm.

In an embodiment of the disclosure, the second sealing component is provided with a first flange along an outer edge of a circumferential direction of the first deck surface, and an outer edge of the circumferential direction of the first sealing component is correspondingly matched with the first flange to form a seal.

In an embodiment of the disclosure, the first sealing component is provided with a second flange along an inner edge of the circumferential direction of the second deck surface. The second flange extends toward one side of the reducer, and the first deck surface is provided with a sealing groove matched with the second flange. The second flange is embedded in the sealing groove, and the second flange is matched with the sealing groove to form a seal.

One or more embodiments of the disclosure further provide a mower. The mower includes a first wheel, a second wheel, an operating mechanism and a control assembly. The first wheel and the second wheel are respectively arranged at the two side of the vehicle frame of the mower. The operating mechanism is used to adjust the rotating speeds and/or the steerings of the first wheel and the second wheel, and provided with the detection device to detect the displacement of the operating mechanism, and the detection device is electrically connected with the control assembly. The control assembly is configured to receive the deviation correction command, and automatically compare the extremum rotating speed of the first wheel with the extremum rotating speed of the second wheel when the mower is calibrated for the deviation correction. Wherein, the extremum rotating speed of the first wheel of second wheel is the wheel rotating speed when the operating mechanism is pushed to the mechanical extremum position. The relationship between the output signal of the detection device and the output rotating speed of the corresponding wheel of the control assembly is corrected to enable the extremum rotating speed of the first wheel to be the same as the extremum rotating speed of the second wheel when there is the difference between the extremum rotating speed of the first wheel and the extremum rotating speed of the second wheel.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a schematic structural view of a garden tool according to an embodiment of the disclosure.

FIG. 2 is a schematic top view of a garden tool according to an embodiment of the disclosure.

FIG. 3 is a schematic structural view of an operating mechanism of a garden tool according to an embodiment of the disclosure.

FIG. 4 is a first exploded view of an operating mechanism of a garden tool according to an embodiment of the disclosure.

FIG. 5 is a partial schematic structural view of an operating mechanism of a garden tool according to an embodiment of the disclosure.

FIG. 6 is a schematic matching view of an operating handle of an operating mechanism, an operating rod and an angle sensor of a garden tool according to an embodiment of the disclosure.

FIG. 7 is a schematic structural view of a reset assembly of an operating mechanism of a garden tool according to an embodiment of the disclosure.

FIG. 8 is a schematic structural view of a limiting plate of an operating mechanism of a garden tool according to an embodiment of the disclosure.

FIG. 9 is a linear relationship view of an angle sensor with an opening degree of an operating handle of a garden tool according to an embodiment of the disclosure.

FIG. 10 is a flowchart of a deviation correction method of a garden tool according to an embodiment of the disclosure.

FIG. 11 is a calibration flowchart of a first wheel of a garden tool in a calibration method according to an embodiment of the disclosure.

FIG. 12 is a calibration flowchart of a second wheel of a garden tool in the calibration method according to an embodiment of the disclosure.

FIG. 13 is a schematic structural view of a walking assembly according to an embodiment of the disclosure.

FIG. 14 is a first schematic structural exploded view of a walking assembly according to an embodiment of the disclosure.

FIG. 15 is a schematic structural view of a first sealing ring according to an embodiment of the disclosure.

FIG. 16 is a first schematic cross-sectional structural view of a walking assembly at a connection of a motor and a reducer according to an embodiment of the disclosure.

FIG. 17 is a second schematic structural exploded view of a walking assembly according to an embodiment of the disclosure.

FIG. 18 is a schematic matching view of an oil sealing and a second sealing ring according to an embodiment of the disclosure.

FIG. 19 is a schematic cross-sectional structural view of a second sealing ring according to an embodiment of the disclosure.

FIG. 20 is a second schematic cross-sectional structural view of a walking assembly at a connection of a motor and a reducer according to an embodiment of the disclosure.

FIG. 21 is a third schematic structural exploded view of a walking assembly according to an embodiment of the disclosure.

FIG. 22 is a schematic cross-sectional structural view of a walking assembly at a connection of a motor and a reducer according to an embodiment of the disclosure.

FIG. 23 is a fourth schematic structural exploded view of a walking assembly according to an embodiment of the disclosure.

FIG. 24 is a schematic cross-sectional structural view of a walking assembly at a connection of the motor and a reducer according to an embodiment of the disclosure.

FIG. 25 is a perspective view of a garden tool according to an embodiment of the disclosure.

FIG. 26 is a schematic structural connecting view of a walking driving device and the walking assembly in a garden tool according to an embodiment of the disclosure.

### PART NUMBER DESCRIPTION

10—garden tool, 100—vehicle frame, 110—walking assembly, 111—first wheel, 112—second wheel, 200—operating mechanism, 201—first operating mechanism, 202—second operating mechanism, 210—operating installation base, 211—first rotating shaft, 212—second rotating shaft, 213—limiting plate, 214—limiting hole, 2141—first orientation hole, 2142—second orientation hole, 215—angle sensor, 220—operating handle, 230—operating rod, 231—first protrusion, 232—through hole, 240—reset assembly, 241—spring base, 242—compression spring, 250—damper assembly, 260—pushing rod, 300—mowing assembly, 310—cutting deck, 320—cutter assembly, 400—control assembly, 5101—first driving motor, 5102—second driving motor, 5110—first groove, 5120—third protrusion, 5201—first reducer, 5202—second reducer, 5210—outer tooth ring, 5211—outer tooth ring end surface, 5300—first sealing component, 5310—first sealing ring, 5311—first elastic structure, 5312—second protrusion, 5313—second groove, 5320—second sealing ring, 5321—third groove, 5322—second elastic structure, 5330—end surface pressing plate, 5331—first deck surface, 5332—second flange, 5400—second sealing component, 5410—oil sealing, 5411—tightening steel ring, 5412—lip edge, 5420—rotating frame, 5421—second deck surface, 5422—first flange, 5423—sealing groove, 5500—clamping hood

### DETAILED DESCRIPTION

The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure. It should be noted that, the following embodiments and the features in the embodiments can be combined with each other without conflict. It should further be understood that the terms used in the examples of the disclosure are used to describe specific embodiments, instead of limiting the protection scope of the disclosure. The test methods that do not indicate specific conditions in the following examples are usually in accordance with conventional conditions, or conditions recommended by each manufacturer.

It should be noted that terms “upper”, “lower”, “left”, “right”, “middle” and “one” quoted in this specification are only for a convenience of description, and are not used to limit a scope of the disclosure. Changes or adjustments in their relative relationships shall also be regarded to be within the scope of the disclosure when there is no substantial change in the technical content.

Although battery-powered garden tools may control the wheel rotating speed through the control assembly, the vehicle cannot know the user's usage, and further cannot determine whether the wheels on the left and right sides of the garden tool are running at a constant speed or turning control. Therefore, the garden tool is prone to deviation when moving forward or backward at full speed. During this period, the user needs to constantly adjust the opening degree of the handle to maintain the stability of the vehicle's forward direction.

In addition, the motor of the conventional garden tool is in a transmission connection with the wheel through the reducer at the output end. The driving mechanism of the motor-driven planetary gear reducer commonly seen on the market has a certain gap at the connection position between the motor assembly and the reducer to prevent friction between the stationary motor assembly and the planetary reducer. The existence of this gap enables it to be easy for foreign matter and impurities to enter the transmission structure in a harsh environment, causing premature failure of the internal parts of the reducer.

Therefore, a calibration method of a garden tool, garden tool and mower is necessary to solve the problems mentioned above.

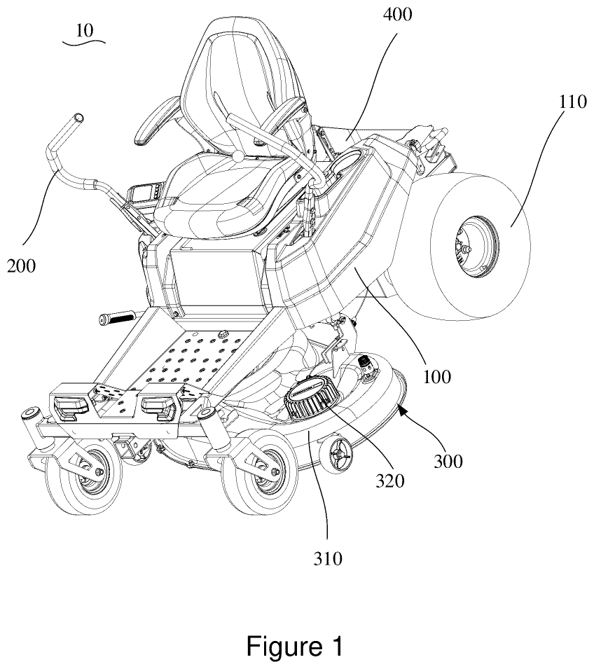

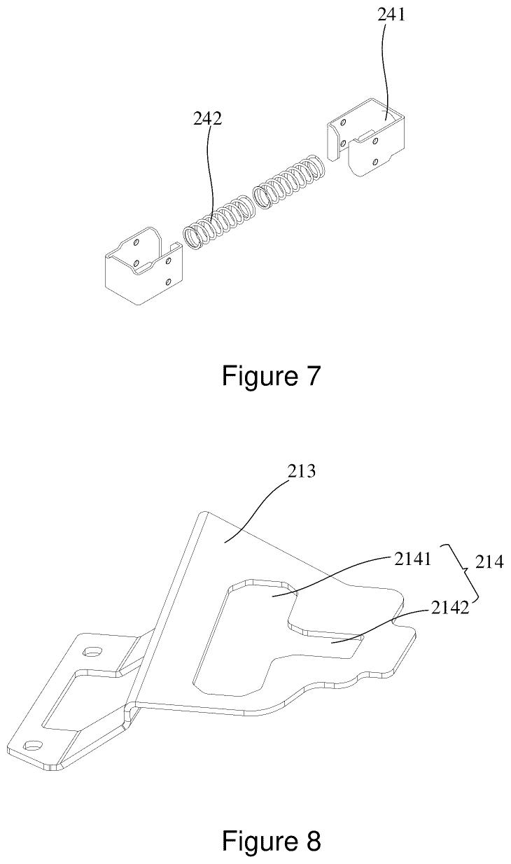

Please refer to FIG. 1 through FIG. 12. The disclosure provides a calibration method of a garden tool 10, the garden tool 10 and a mower. Through correcting a relationship between an output signal of a detection device and an output rotating speed of a control assembly, extremum rotating speeds of wheels on two sides are kept consistent, thereby achieving a deviation correction.

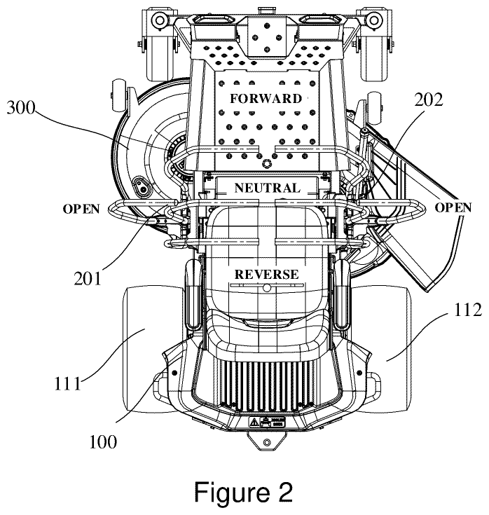

The garden tool 10 may be any type of garden tool 10 with symmetrical wheels on two sides of the vehicle frame 100, including but not limited to a mower, a snow blower, a rotary tiller, etc. Please refer to FIG. 1 and FIG. 2. Taking the mower as an example, the garden tool 10 of the disclosure includes the vehicle frame 100, a walking assembly 110, an operating mechanism 200, a mowing assembly 300 and a control assembly 400. The vehicle frame 100 serves as a main structure of the garden tool 10 and provides support and installation space for other structures of the garden tool 10. The walking assembly 110, the operating mechanism 200, the mowing assembly 300 and the control assembly 400 are respectively assembled on the vehicle frame 100, and the walking assembly 110, the operating mechanism 200, and the mowing assembly 300 are respectively electrically connected with the control assembly 400. The walking assembly 110 is used to drive the garden tool 10 to walk. The operating mechanism 200 is used to adjust a rotating speed and/or a steering of the walking assembly 110, and the mowing assembly 300 is used to mow. The control assembly 400 controls a movement, steering, mowing and other actions of the garden tool 10 by controlling an operation of the walking assembly 110, the operating mechanism 200 and the mowing assembly 300.

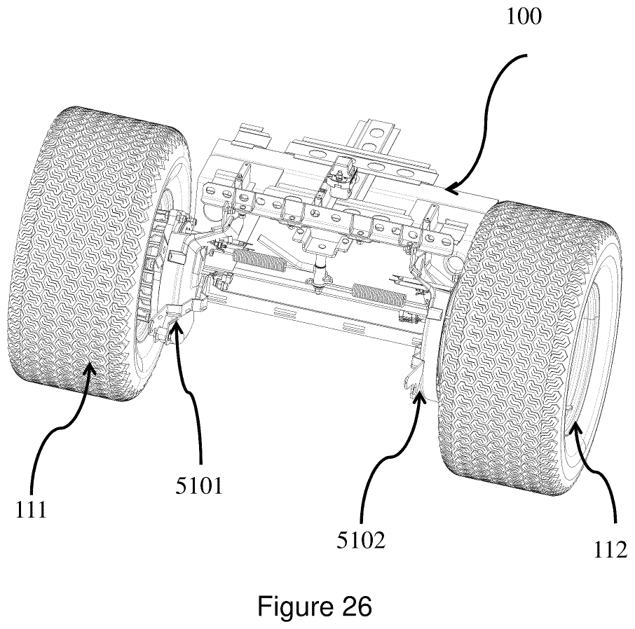

Please refer to FIG. 1, FIG. 2 and FIG. 26. The walking assembly 110 includes a first wheel 111 and a second wheel 112. The first wheel 111 and the second wheel 112 are respectively installed at left and right sides of the vehicle frame 100. In this embodiment, the first wheel 111 and the second wheel 112 are driving wheels. The walking assembly 110 further includes a first driving motor 5101 for driving the first wheel 111 and a second driving motor 5102 for driving the second wheel 112. An output end of the first driving motor 5101 is fixedly connected with the first wheel 111, and an output end of the second driving motor 5102 is fixedly connected with the second wheel 112. When the first driving motor 5101 and the second driving motor 5102 drive the first wheel 111 and the second wheel 112 at the same rotating speed, the garden tool 10 moves forward or backward. When the first driving motor 5101 and the second driving motor 5102 drive the first wheel 111 and the second wheel 112 at different rotating speeds, a speed difference is generated between the first wheel 111 and the second wheel 112, so that the garden tool 10 turns. In other embodiments, the first wheel 111 and the second wheel 112 may also be driven by hub motors or the like.

Further, the control assembly 400 is used to control an operation process of the wheel. In some embodiments, the control assembly 400 uses a dedicated controller, such as some dedicated control chips (eg, MCU, Microcontroller Unit). A control module is integrated with a signal processing unit, wherein the signal processing unit is used to process relevant parameter signals, and has functions of calculation, comparison, determination, etc. After processing a signal, the signal processing unit can generate a control signal to output to the driving motor to drive the wheel to rotate. In this embodiment, the control assembly 400 includes a first controller and a second controller. The first controller is electrically connected with the first driving motor 5101, and the second controller is electrically connected with the second driving motor 5102. The first controller controls the rotating speed of the first wheel 111 by controlling a rotating speed of the first driving motor 5101. The second controller controls the rotating speed of the second wheel 112 by controlling a rotating speed of the second driving motor 5102. The control assembly 400 controls the operation of the walking assembly 110 through the first controller and the second controller. In some embodiments, the first controller and the second controller are established in a same communication network, including but not limited to RS485/RS422/CAN/LIN and other communication methods. The first controller and the second controller send the rotating speeds of the first driving motor 5101 and the second driving motor 5102 to the communication network in real time, and the first controller and the second controller can recognize the rotating speeds sent by each other and compare them with the rotating speeds sent by themselves to obtain the rotating speeds of the first wheel 111 and the second wheel 112 in real time. Those skilled in the art may understand that, in another embodiment, the control assembly 400 may also include only one controller, and the rotating speeds of the first wheel 111 and the second wheel 112 may be controlled by a same controller.

Please refer to FIG. 1 through FIG. 3. In an embodiment, the garden tool 10 includes two operating mechanisms 200, the two operating mechanism 200 are respectively used to adjust the rotating speed of the first wheel 111 and the rotating speed of the second wheel 112. The operating mechanism 200 for adjusting the rotating speed of the first wheel 111 is recorded as the first operating mechanism 201, and the operating mechanism 200 for adjusting the rotating speed of the second wheel 112 is recorded as the second operating mechanism 202. The first operating mechanism 201 and the second operating mechanism 202 is provided with a same structure, and the first operating mechanism 201 and the second operating mechanism 202 are both provided with a detection device for detecting a displacement of the corresponding operating mechanism. The first operating mechanism 201 and the second operating mechanism 202 are respectively electrically connected with the corresponding first controller and the second controller through the detection device. This means that the detection device outputs a corresponding electrical signal according to the displacement generated by a rotation of an operating part of the operating mechanism 200. The detection device transmits the electrical signal to the control assembly 400. The control assembly 400 outputs a corresponding rotating speed to the driving motor according to the electrical signal to realize a rotation of the wheel. The above displacement includes a linear displacement and/or an angular displacement. The detection device in this embodiment is an angle sensor 215. The angle sensor 215 may generate different angular displacements according to an amplitude of the operating part and output corresponding voltages to output a voltage signal to the control assembly 400. The control assembly 400 sends a corresponding rotating speed instruction to the corresponding driving motor according to the voltage, so as to control a forward, backward or steering movement of the garden tool 10, and controls a speed of the garden tool 10 according to an amplitude of the specific angular displacement. Of course, in other embodiments, the detection device may also be other devices for detecting hand operations, including but not limited to displacement sensors, light sensors or pressure sensors, etc., which are not limited here.

Please refer to FIG. 2 through FIG. 6. In an embodiment, the first operating mechanism 201 is installed on the vehicle frame 100 at one side of the first wheel 111 and is used to adjust the rotating speed of the first wheel 111. The second operating mechanism 202 is installed on the vehicle frame 100 at one side of the second wheel 112. Structures of the first operating mechanism 201 and the second operating mechanism 202 are the same, each of them includes an operating installation base 210, an operating handle 220 and an operating rod 230. The operating installation base 210 is fixedly installed on the vehicle frame 100, the operating rod 230 is rotatably installed in the operating installation base 210 along a first direction, and the operating handle 220 is arranged above the operating rod 230 and is rotatably connected with the operating rod 230 along a second direction. Wherein, the first direction is a forward-back direction of the garden tool 10, and the second direction is a left-right direction of the garden tool 10. In an embodiment, the operating installation base 210 is fixed to the vehicle frame 100 by fasteners, such as bolts. An upper end and a lower end of the operating installation base 210 are open structures. The operating rod 230 is installed in the operating installation base 210 along a vertical direction. A top end of the operating rod 230 is rotatably connected with the operating installation base 210 through a rotating shaft. The rotating shaft is recorded as a first rotating shaft 211 here. The first rotating shaft 211 passes through the operating installation base 210. Two ends of the first rotating shaft 211 are respectively installed on side walls of the operating installation base 210 through shaft rings. The operating handle 220 is for the user to hold, and the operating handle 220 is rotatably installed above the operating rod 230 through the second rotating shaft 212. In some embodiments, a pushing rod 260 is connected with the operating handle 220, a first end of the pushing rod 260 is fixedly connected with the operating handle 220, and a second end of the pushing rod 260 is bent in an L shape for easy holding by an operator. In other embodiments, the operating handle 220 and the pushing rod 260 may also be integrated together.

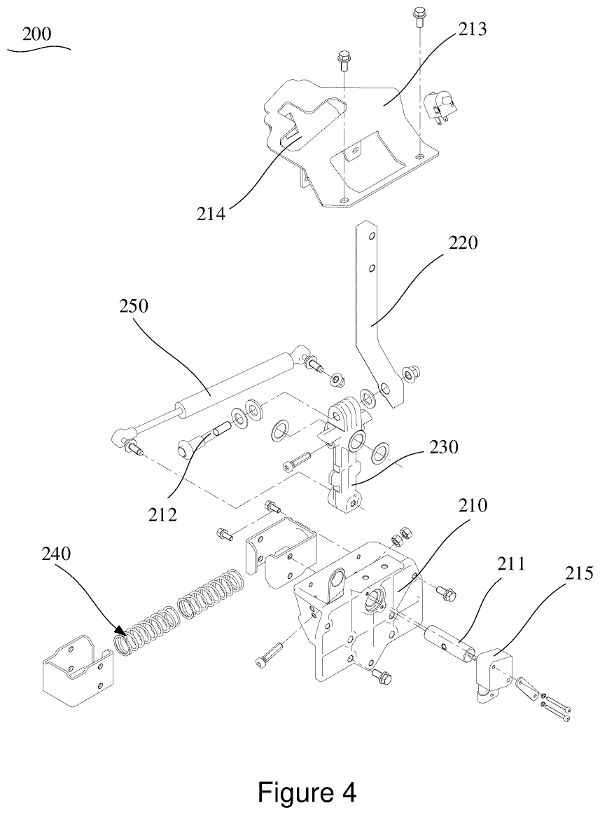

Please refer to FIG. 4 through FIG. 7. The operating mechanism 200 further includes a reset assembly 240, and the reset assembly 240 is fixedly installed on the operating installation base 210 and connected with the operating rod 230. Under an action of the reset assembly 240, the operating rod 230 may swing along a first direction in the operating installation base 210. The reset assembly 240 includes a spring base 241 and a compression spring 242. The spring base 241 is fixedly installed on a bottom of the operating installation base 210. The compression spring 242 is arranged inside the spring base 241. A first end of the compression spring 242 is connected with the spring base 241, and a second end of the compression spring 242 is connected with the operating rod 230. In some embodiments, the reset assembly 240 includes two compression springs 242, the two compression springs 242 are respectively arranged at two ends of the spring base 241, and the operating rod 230 penetrates through the operating installation base 210 from top to bottom, a bottom part of the operating rod 230 is inserted between the two compression springs 242, and is connected with two compression springs 242. In some embodiments, first protrusions 231 matched with the two compression springs 242 are arranged on two sides of the operating rod 230 facing the compression springs 242 respectively, and the operating rod 230 is elastically connected with the reset assembly 240 through the first protrusions 231 on the two sides. When the operating handle 220 drives the operating rod 230 to rotate around the first rotation in the operating installation base 210, the operating rod 230 squeezes the compression springs 242 on the two sides. Due to an elastic effect of the compression spring 242, after releasing the operating handle 220, the operating handle 220 may drive the operating rod 230 to automatically return to a middle position. The spring base 241 in this embodiment may be an integral structure, and two compression springs 242 are respectively arranged at the two ends of the spring base 241. The spring base 241 may also be a separating structure, and one compression spring 242 corresponds to one spring base 241.

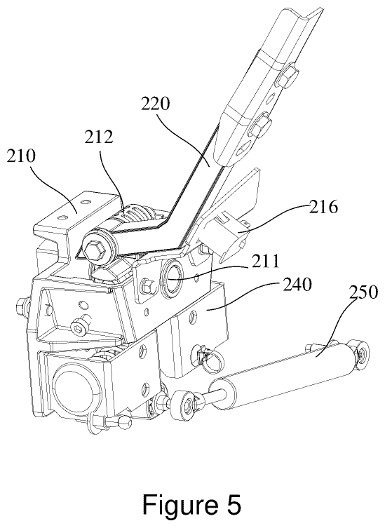

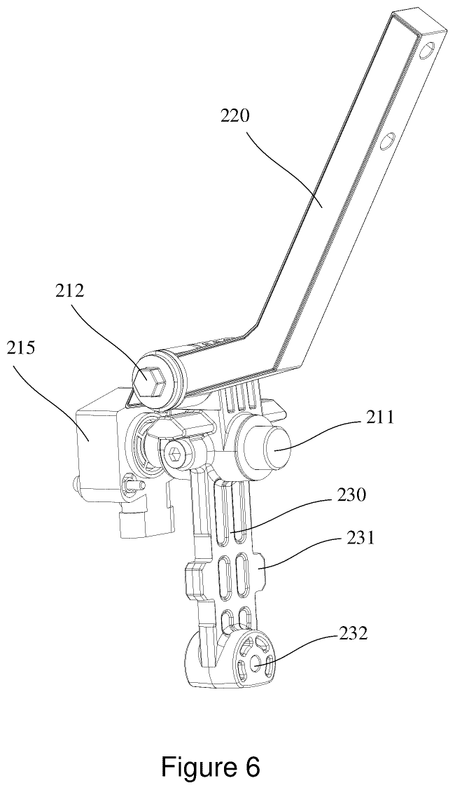

Please refer to FIG. 5 and FIG. 6. In some embodiments, the operating mechanism 200 further includes a damper assembly 250, one end of the damper assembly 250 is installed in the through hole 232 at a bottom of the operating rod 230. The damper assembly 250 is used to provide a damping force for the operating handle 220 during driving operation or automatic return, which enables an operation and an automatic return to be more comfortable and smooth, and reduces an impact force of the operation and return.

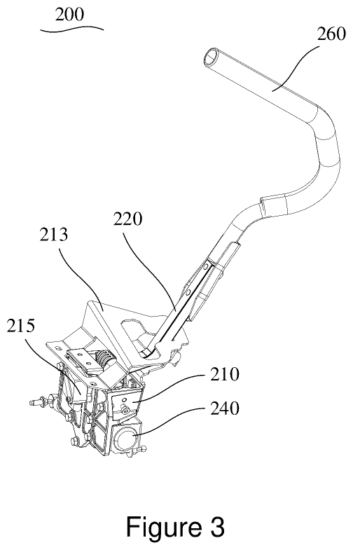

Please refer to FIG. 3, FIG. 4 and FIG. 8. The operating mechanism 200 further includes a limiting plate 213, and the limiting plate 213 is arranged above the operating installation base 210 and fixed to the vehicle frame 100 or the operating installation base 210 by fasteners. The limiting plate 213 is provided with a limiting hole 214, and the limiting hole 214 includes a first orientation hole 2141 and a second orientation hole 2142. The first orientation hole 2141 corresponds to a rotating amplitude of the operating rod 230 in the first direction, and the second orientation hole 2142 corresponds to a rotating amplitude of the operating handle 220 in the second direction. The first orientation hole 2141 and the second orientation hole 2142 are communicated with each other. In an initial position, the operating handle 220 is inserted into the second orientation hole 2142. When the garden tool 10 is started, the operating handle 220 is first rotated in the second direction to enable it to rotate out of the second orientation hole 2142 and enter the first orientation hole 2141, then the operating handle 220 is rotated in the first direction, and the operating handle 220 drives the operating rod 230 to swing in the first orientation hole 2141.

For a convenience of description, the angle sensor on the first operating mechanism 201 is referred to as a first angle sensor, and the angle sensor on the second operating mechanism 202 is referred to as a second angle sensor. A rotating shaft of the first angle sensor rotates synchronously with the operating rod 230 of the first operating mechanism 201. For example, the rotating shaft of the first angle sensor is fixedly connected with the first rotating shaft 211, and the first angle sensor is electrically connected with the first controller. There is a linear relationship between an opening degree of the operating handle 220 of the first operating mechanism 201 (which means a rotating angle of the operating rod in the operating installation base) and an output voltage of the first angle sensor. This means that the operating rod 230 of the first operating mechanism 201 rotates a certain angle under a drive of the operating handle 220, and the first angle sensor feeds back the output voltage to the first controller. The first controller receives the output voltage of the first angle sensor and outputs a rotating speed of the first driving motor 5101 according to a preset proportional relationship between the output voltage and the rotating speed of the driving motor, thereby realizing a rotation of the first wheel 111. Similarly, the second angle sensor is electrically connected with the second controller, a rotating shaft of the second angle sensor rotates synchronously with the operating rod 230 of the second operating mechanism 202, and an opening degree of the operating handle of the second operating mechanism 202 is linearly related to an output voltage of the second angle sensor. This means that the operating rod 230 of the second operating mechanism 202 rotates a certain angle under the drive of the operating handle 220, and the second angle sensor feeds back the output voltage to the second controller. The second controller receives the output voltage of the second angle sensor and outputs a rotating speed of the second driving motor 5102 according to a preset proportional relationship between the output voltage and the rotating speed of the motor, thereby realizing a rotation of the second wheel 112.

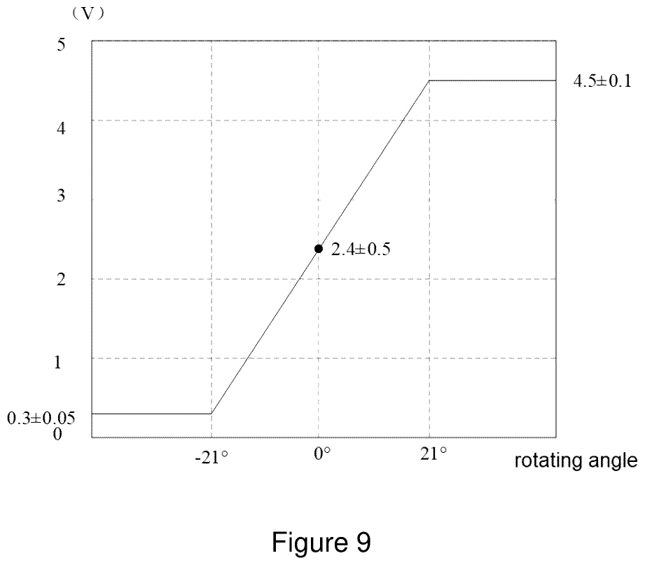

Please refer to FIG. 9. In an embodiment of the disclosure, a voltage range of the angle sensor output is set to be from 0 V to 5 V. When the operating handle 220 is in a first position (a middle position, which means a rotating angle of the operating handle along the first direction is 0°), the voltage output by the angle sensor is 2.4 V±0.5V. When the operating handle 220 is in a second position (a front end of the first direction, which means a maximum rotating angle of the operating handle along the forward direction of the garden tool 10), the voltage output by the angle sensor is 4.5 V±0.1 V. When the operating handle 220 is in a third position (a rear end of the first direction, which means the maximum rotating angle of the operating handle along the backward direction of the garden tool 10), the voltage output by the angle sensor is 0.3 V±0.05 V. Correspondingly, a rotating angle α of the operating handle 220 in the first direction is set to be from −21° to 21°, and the output voltage of the angle sensor is positively linearly correlated with the rotating angle α, which means that when the rotating angle α of the operating handle 220 is −21°, 0° and 21°, respectively, corresponding to the rear end, the middle position and the front end of the limiting hole 214, and the corresponding output voltages of the angle sensor are 0.3 V±0.05V, 2.4 V±0.5 V and 4.5 V±0.1V, respectively. In other words, the operating handle 220 may output a high voltage signal when it is rotated in the forward direction of the garden tool 10, and may output a low voltage signal when it is rotated in the backward direction of the garden tool 10. For example, when the operating handle 220 is in the middle position (the opening degree is 0°), the output voltage of the angle sensor is 2.4 V. When trying to drive the garden tool 10 forward, the opening degree of the operating handle needs to be increased in a positive direction, which means from 0° to 21°. The corresponding output voltage of the angle sensor gradually increases from 2.4 V to 4.5 V. At this time, the wheel is rotating in the positive direction. The higher the output voltage, the higher the rotating speed. When trying to drive the garden tool 10 backward, the opening degree of the operating handle needs to be increased in an opposite direction, which means decreased from 0° to −21°. The corresponding output voltage of the angle sensor gradually decreases from 2.4 V to 0.3 V. When the voltage is less than 2.4V, the wheel turns to the opposite direction. The lower the output voltage, the lower the rotating speed. The output voltage of the angle sensor and the rotating speed of the driving motor satisfy a relationship y=kx+b, where y is the rotating speed of the driving motor, x is the output voltage of the angle sensor, and k and b are constants.

In one embodiment, the mowing assembly 300 includes a cutting deck 310 and a cutter assembly 320. The cutting deck 310 is installed at a front bottom of the vehicle frame 100. A plurality of cutter assemblies 320 is installed on the cutting deck 310. The cutter assembly 320 includes a blade and a mowing motor. The mowing motor is fixedly installed on the cutting deck 310, and the blade is fixedly installed on an output shaft of the mowing motor. The mowing motor drives the corresponding blade to rotate to mow.

In one embodiment, the garden tool 10 further includes a battery assembly, which is installed on the vehicle frame 100 to provide power for structures such as the walking assembly 110 and the mowing assembly 300. Other structures of the garden tool 10 not described in details may be realized by conventional technical means.

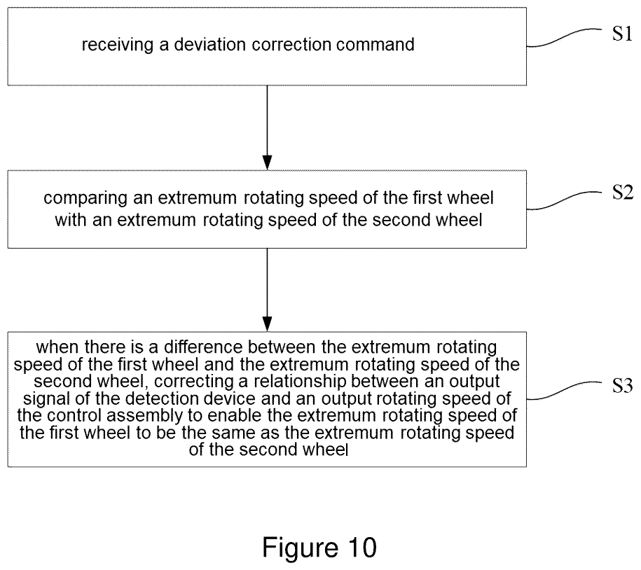

Please refer to FIG. 10. A calibration method of the garden tool 10 of the disclosure includes operations S1-S3 as follows.

S1, a deviation correction command is received.

S2, an extremum rotating speed of the first wheel 111 is compared with an extremum rotating speed of the second wheel 112, and the extremum rotating speed is a wheel rotating speed of the first wheel 111 or the second wheel 112 when the operating mechanism 200 is pushed to a mechanical extremum position.

S3, when there is a difference between the extremum rotating speed of the first wheel 111 and the extremum rotating speed of the second wheel 112 (which means the extremum rotating speed of the first wheel 111 is greater than or less than the extremum rotating speed of the second wheel 112), a relationship between an output signal of the detection device and an output rotating speed of the control assembly 400 is corrected to enable the extremum rotating speed of the first wheel 111 to be the same as the extremum rotating speed of the second wheel 112.

Specifically, the deviation correction command in S1 may be sent by the control assembly 400 itself. For example, the control assembly 400 further includes an operation panel (dashboard), various function buttons are provided on the operation panel, such as a deviation correction button. The first controller and the second controller of the walking assembly 110 are both electrically connected with the control assembly 400. The control assembly 400 sends a deviation correction command to the first controller and the second controller through the deviation correction button on the operation panel. Wherein, the deviation correction command may be sent by an IO command or a communication command. However, in other embodiments, the deviation correction command may also be sent by an external device independent of the control assembly 400.

Before sending the deviation correction command, the operating mechanisms 200 of the first wheel 111 and the second wheel 112 are pushed to a mechanical extremum position (a maximum angle of a rotation of the operating handle in the operating installation base along the first direction, which means that the operating handle is pushed to the second position or the third position) respectively. A deviation problem may be solved by keeping the rotating speed of the first wheel 111 and the second wheel 112 synchronized at the mechanical extremum position of the operating mechanism 200. Specifically, the operating handle 220 of the first operating mechanism 201 is pushed to a mechanical extremum position, and the operating handle of the second operating mechanism 202 is pushed to the mechanical extremum position. The mechanical extremum positions of the operating handle 220 of the first operating mechanism 201 and the operating handle 220 of the second operating mechanism 202 may be maximum angles of a rotation along the forward direction of the garden tool 10, which means that the operating handle 220 is pushed to the second position, or it may be the maximum angle of a rotation along the backward direction of the garden tool 10, which means that the operating handle 220 is pushed to the third position, but the directions of the two must be consistent, which means that they are rotated forward to the second position at the same time or rotated reversely to the third position at the same time.

In S2, since the first controller and the second controller will send their respective rotating speeds to the communication network in real time and can recognize each other, after receiving the deviation correction command, the first controller and the second controller will automatically identify the current rotating speed (extremum rotating speed) of the first wheel 111 and the rotating speed (extremum rotating speed) of the second wheel 112. If the rotating speed of the first wheel 111 and the rotating speed of the second wheel 112 are both greater than zero, S3 is executed. If one or both of the rotating speed of the first wheel 111 and the rotating speed of the second wheel 112 do not meet a condition of being greater than zero, a process returns to S1.

In S3, correcting the relationship between the output signal of the detection device and the output rotating speed of the control assembly 400 specifically includes a correction of the first controller and a correction of the second controller.

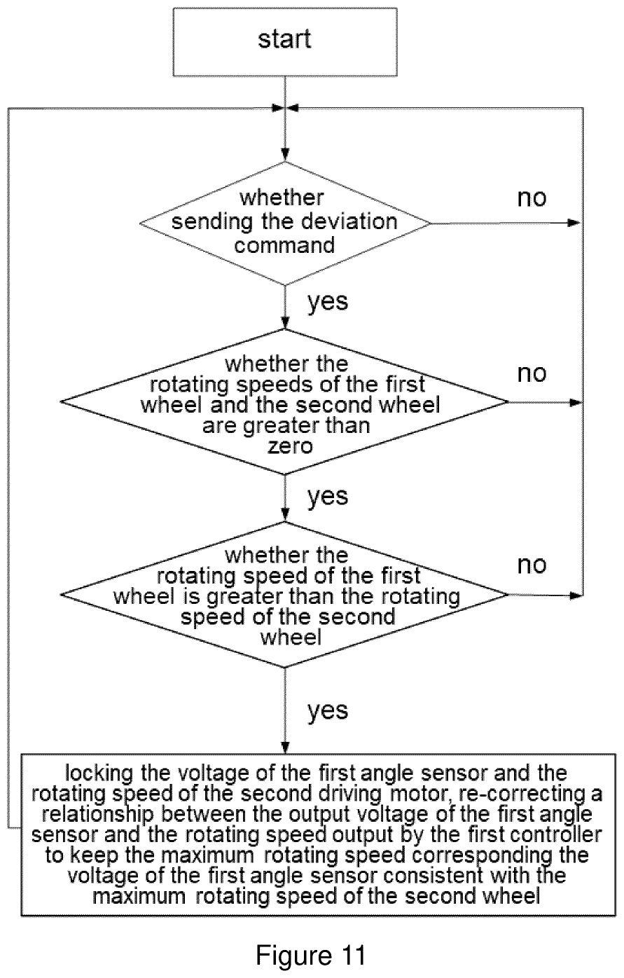

Please refer to FIG. 10 and FIG. 11. After receiving the deviation correction command, the first controller compares the rotating speed V1 issued by itself and the rotating speed V2 issued by the second controller. If V1 is less than V2, the first controller does not respond. If V1 is greater than V2, the first controller locks the current output voltage U1 of the first angle sensor and the rotating speed V2 issued by the second controller, and corrects a relationship between the output voltage of the first angle sensor and the rotating speed of the first driving motor 5101 based on U1 and V2, so that the maximum rotating speed corresponding to the current voltage U1 of the first angle sensor is consistent with the extremum rotating speed V2 of the second driving motor 5102.

An example is as follows: it is assumed that when the operating handle is in the middle position, the output voltage of the angle sensor is 2.4 V, and the corresponding rotating speed is 0 rpm at this time. When the operating handle is pushed to the front end (the second position), the output voltage of the angle sensor is 4.5 V, and the maximum rotating speed limit value is 4200 rpm, then (2.4, 0) and (4.5, 4200) are substituted into the relationship y=kx+b to calculate k=2000, b=−4800. Thus, a relationship between an original set maximum rotating speed limit value output by the control assembly 400 and the voltage of the angle sensor is: y=2000x−4800 (1), where x is the voltage and y is the maximum rotating speed limit value. Due to mechanical errors, wear and other problems, there is a deviation in the rotating speeds of the wheels on the two sides. For example, when the operating handle is pushed to the front end, the rotating speed V1 output by the first controller is 4200 rpm, and the rotating speed V2 output by the second controller is 3780 rpm. The output voltage of the first angle sensor at this time is 4.5 V, and the rotating speed 3780 rpm output by the second controller is locked. (2.4, 0) and (4.5, 3780) are substituted into the relationship y=kx+b, then k=1800 and b=−4320 are calculated. At this time, the relationship between the maximum rotating speed and the voltage of the first angle sensor is revised from formula (1) to: y=1800x−4320 (2). Subsequently, the first controller outputs the rotating speed of the first wheel 111 according to the formula (2), so that when the opening degrees of the operating handle of the first operating mechanism 201 and the operating handle of the second operating mechanism 202 are the same, the rotating speeds of the first wheel 111 and the second wheel 112 are consistent, thereby achieving the deviation correction.

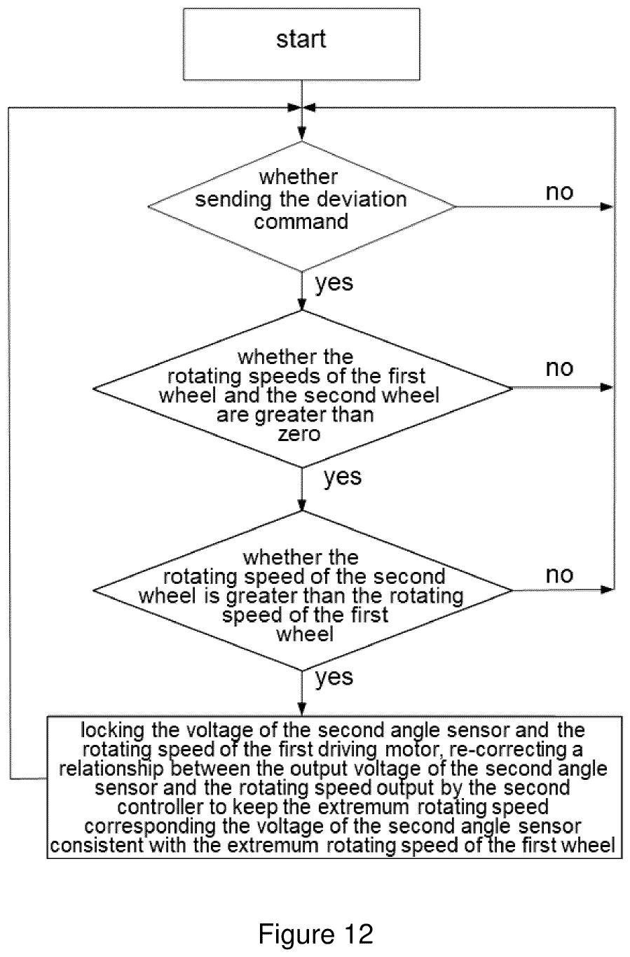

Please refer to FIG. 10 and FIG. 12. Similarly, after receiving the deviation correction command, the second controller 220 compares the rotating speed V2 issued by itself and the rotating speed V1 issued by the first controller 210. If V2 is less than V1, the second controller 220 does not respond. If V2 is greater than V1, the second controller 220 locks the current output voltage U2 of the second angle sensor and the rotating speed V1 issued by the first controller, and corrects a relationship between the output voltage of the second angle sensor and the rotating speed of the second controller based on U2 and V1, so that the maximum rotating speed corresponding to the current voltage U2 of the second angle sensor is consistent with the extremum rotating speed V1 of the first driving motor 5101. A revision process is the same as that of the first controller. Subsequently, the second controller outputs the rotating speed of the second wheel 112 according to a newly revised relationship between the voltage of the angle sensor and the rotating speed, so that when the opening degrees of the operating handle of the first operating mechanism 201 and the operating handle of the second operating mechanism 202 are the same, the rotating speeds of the second wheel 112 and the first wheel 111 are consistent, thereby achieving the deviation correction.

The garden tool 10 of the disclosure establishes the controllers of the wheels on the two sides in the same communication network so that the controllers can recognize the wheel rotating speeds controlled by each other. By utilizing this characteristic, when the garden tool 10 is calibrated for deviation correction, the operating handles of the wheels on the two sides are pushed to the mechanical extremum position. If the rotating speeds of the wheels on the two sides are different at this time, the extremum rotating speeds of the wheels on the two sides may be kept consistent through correcting a relationship between an electrical signal of the detection device and the output rotating speed of the control assembly 400.

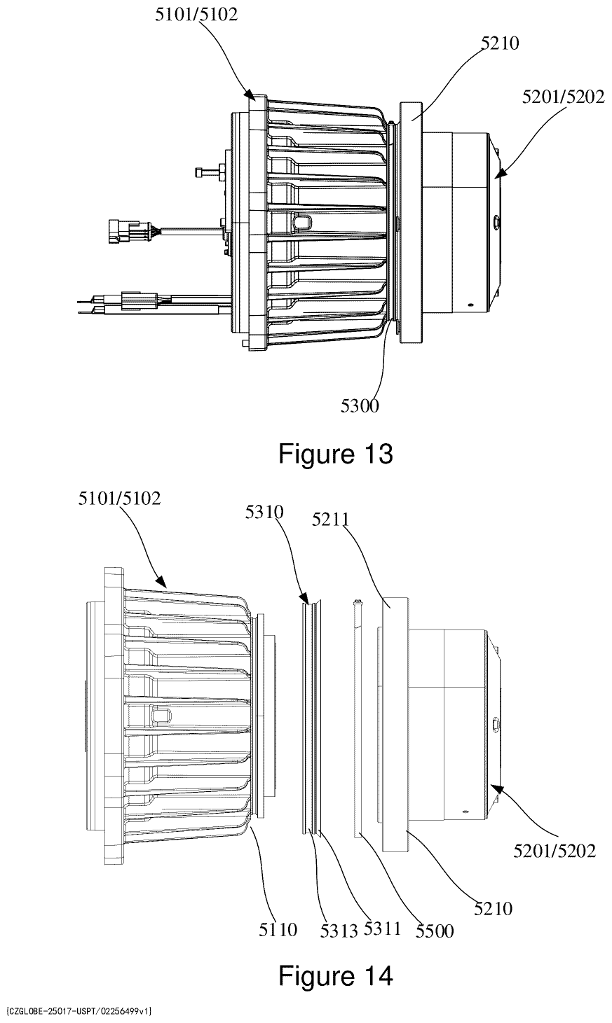

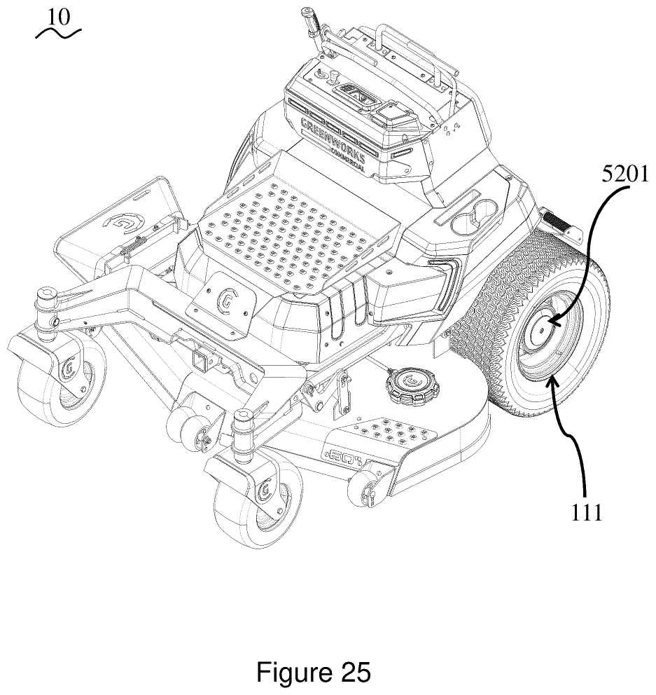

Please refer to FIG. 13 through FIG. 26. The walking assembly 110 further includes a first reducer 5201, a second reducer 5202 and a sealing structure. The first wheel 111 and the second wheel 112 are arranged at the two sides of the vehicle frame 100. The first wheel 111 and the second wheel 112 may be inflatable wheels that includes a tire and a wheel hub, for example, or may be the integrated wheel made of polymer. A structure of the wheel is not limited to a certain form. The first wheel 111 and the second wheel 112 are driven by corresponding driving motors and reducers, respectively. In an embodiment, the first reducer 5201 is coaxially connected with the first driving motor 5101, the first wheel 111 is coaxially connected with the first reducer 5201, and the first driving motor 5101 drives the first wheel 111 to rotate through the first reducer 5201. The second reducer 5202 is coaxially connected with the second driving motor 5102, the second wheel 112 is coaxially connected with the second reducer 5202, and the second driving motor 5102 drives the second wheel 112 to rotate through the second reducer 5202. A connection position between the first driving motor 5101 and the first reducer 5201, as well as a connection position between the second driving motor 5102 and the second reducer 5202 are both provided with the sealing structures, a sealed fit is formed between the first driving motor 5101 and the first reducer 5201 through the sealing structure, and a sealed fit is also formed between the second driving motor 5102 and the second reducer 5202 through the sealing structure. The garden tool 10 provides electric energy for the first driving motor 5101 and the second driving motor 5102 through a power battery. It should be noted that, in other embodiments, it is also possible to provide the sealing structure only at the connection position between the first driving motor 5101 and the first reducer 5201 or to provide the sealing structure only at the connection position between the second driving motor 5102 and the second reducer 5202. In this embodiment, in the walking assembly 110 of the garden tool 10, the sealing structure is arranged at a connection of the driving motor and the reducer to realize a sealing along a circumferential surface and/or a radial surface of the connection, so as to solve a technical problem that in the walking assembly 110 of the prior art, there is a gap between the motor and the reducer, and foreign matter and impurities are easy to enter in a harsh environment, which may cause the reducer to fail.

In an embodiment, in order to cooperate with the sealing structure, a center of the wheel needs to have a cavity that can accommodate the corresponding reducer or even the driving motor. The power battery is fixed on the vehicle frame 100 and is electrically connected with the first driving motor 5101 and the second driving motor 5102 to provide power to the first driving motor 5101 and the second driving motor 5102. The first driving motor 5101 and the second driving motor 5102 are fixedly arranged on the vehicle frame 100, and may serve as a supporting structure connecting the first wheel 111, the second wheel 112 and the vehicle frame 100. An output end of the first driving motor 5101 is provided with a first reducer 5201, a power input end of the first reducer 5201 is coaxially connected with an output shaft of the first driving motor 5101, and a power output end of the first reducer 5201 is coaxially connected with the first wheel 111. An output end of the second driving motor 5102 is provided with a second reducer 5202, a power input end of the second reducer 5202 is coaxially connected with an output shaft of the second driving motor 5102, and the power output end of the second reducer 5202 is coaxially connected with the second wheel 112. For example, the first reducer 5201 and the second reducer 5202 is the planetary reducers, the two planetary reducers are respectively arranged in cavities of the first wheel 111 and the second wheel 112, and an outer tooth ring 5210 serving as a power output end of the planetary reducer is connected with the corresponding cavity of the first wheel 111 or the second wheel 112.

Please refer to FIG. 13. In an embodiment, in order to increase the circumferential sealing area of the sealing structure, the sealing structure extends radially or circumferentially from axial overlapping positions of the first driving motor 5101 and the first reducer 5201 (or the second driving motor 5102 and the second reducer 5202), and the sealing fit is formed on the circumferential surface and/or the radial surface at the axial overlapping position, so as to realize that foreign matters are prevented from entering the rotating gap between the reducer 5200 and the driving motor 5100.

It should be noted that, a type of working assembly used in the above-mentioned garden tool 10 may be unlimited, and the above-mentioned working assembly may be the mowing assembly 300, a snow throwing assembly, a blower and a sowing assembly and other working components.

Please refer to FIG. 13. Considering that a connecting relationship and a related sealing structure between the first driving motor 5101 and the first reducer 5201 are the same as a connecting structure and a related sealing structure between the second driving motor 5102 and the second reducer 5202, for a convenience of description, only the connecting relationship and the related sealing structure between the first driving motor 5101 and the first reducer 5201 are explained below. The connecting relationship and the related sealing structure between the second driving motor 5102 and the second reducer 5202 may refer to the connecting relationship and the related sealing structure between the first driving motor 5101 and the first reducer 5201.

Please refer to FIG. 13. In an embodiment of the disclosure, the first driving motor 5101 is coaxially arranged with the first reducer 5201, and is fixed and connected with the first reducer 5201 through a bolt. A first sealing component 5300 is coaxially sleeved on the first driving motor 5101 and/or the first reducer 5201, so that it is matched with the first driving motor 5101 and/or the first reducer 5201 at a connection between the first driving motor 5101 and/or the first reducer 5201 to form a seal. For example, in a first embodiment, the first sealing component 5300 is coaxially sleeved along a circumferential direction at the connection of the first driving motor 5101 and the first reducer 5201, and at the same time fitted with the first driving motor 5101 and the first reducer 5201 at an inner ring and/or an outer ring of the first sealing component 5300 to form the seal between the first driving motor 5101 and the first reducer 5201. In a second embodiment, the first sealing component 5300 is coaxial sleeved on one side of a housing of the first reducer 5201 towards the first driving motor 5101, and the first sealing component 5300 is fixedly arranged on an outer tooth ring 5210 of the first reducer 5201, and is relatively fitted with an end face of the housing of the first driving motor 5101 on one side towards the first driving motor 5101 to form the seal. In a third embodiment, the first sealing component 5300 is coaxial sleeved is on the housing of the first driving motor 5101 towards the first reducer 5201, and the first sealing component 5300 is fixedly arranged on a circumferential periphery of the housing of the first driving motor 5101, and is arranged relative to an outer tooth ring end surface 5211 of the first reducer 5201 on one side towards the first reducer 5201. There is a gap between the first sealing component 5300 and the outer tooth ring end surface 5211, and one surface of the first sealing component 5300 towards the first reducer 5201 is matched with the outer tooth ring end surface 5211 on a radial plane to form the sealing structure to realize a sealing protection function of an internal structure of the first reducer 5201 and the first driving motor 5101 without affecting a relative rotation of the first reducer 5201 and the first driving motor 5101.

Wherein, the first reducer 5201 mentioned above is a planetary first reducer 5201, and a characteristic of planetary first reducer 5201 is that it can generate a larger reduction transmission ratio with a smaller axial size, and its axial length may even be less than widths of the first wheel 111 and the second wheel 112, so the first reducer 5201 can be completely hidden in the first wheel 111 and the second wheel 112, which then increases a utilization rate of a lateral space.

Wherein, a gap distance between the first sealing component 5300 and the outer tooth ring end surface 5211 is from 1 mm to 3 mm, and this gap distance may be 1 mm, 2 mm or 3 mm for example.

Please refer to FIG. 14 through FIG. 16. In an embodiment of the disclosure, the first driving motor 5101 is coaxially arranged with the first reducer 5201, and is fixed and connected with the first reducer 5201 through the bolt. The first sealing component 5300 is coaxially sleeved on the housing of one side of the first driving motor 5101 towards the first reducer 5201, and the first sealing component 5300 is fixedly arranged on the circumferential periphery of the housing of the first driving motor 5101. The first sealing component 5300 does not rotate axially on the housing of the first driving motor 5101, and the first sealing component 5300 is arranged relative to the outer tooth ring end surface 5211 of the first reducer 5201 on a plane facing one side of the first reducer 5201.

Please refer to FIG. 14 through FIG. 16. In this embodiment, the first sealing component 5300 is a first sealing ring 5310. The first sealing ring 5310 is sleeved and fixed on a peripheral of the housing of the first driving motor 5101, and the first sealing ring 5310 is provided with a first elastic structure 5311. The first elastic structure 5311 protrudes and is arranged on the surface of the first sealing component 5300 towards the first reducer 5201, and the first elastic structure 5311 extends in a closed loop along the circumferential direction on an end face of the first sealing component 5300. When the first reducer 5201 is coaxially assembled to the first driving motor 5101. A first end of the first sealing ring 5310 is fixed by a sleeve to achieve the sealing structure with the first driving motor 5101, and the first elastic structure 5311 protruding at a second end of the first sealing ring 5310 is interference abutted on the outer tooth ring end surface 5211 of the first reducer 5201 (the outer tooth ring end surface 5211 is a radial plane that is axially connected with the first reducer 5201 relative to the first driving motor 5101). An end of the first elastic structure 5311 abuts and fits on the outer tooth ring end surface 5211 along the radial direction, and prevent an external foreign matter from entering from an abutting position through a friction matching with the outer tooth ring end surface 5211 when the outer tooth ring 5210 rotates, so as to form the sealing structure that does not affect an axial rotation of the first reducer 5201.

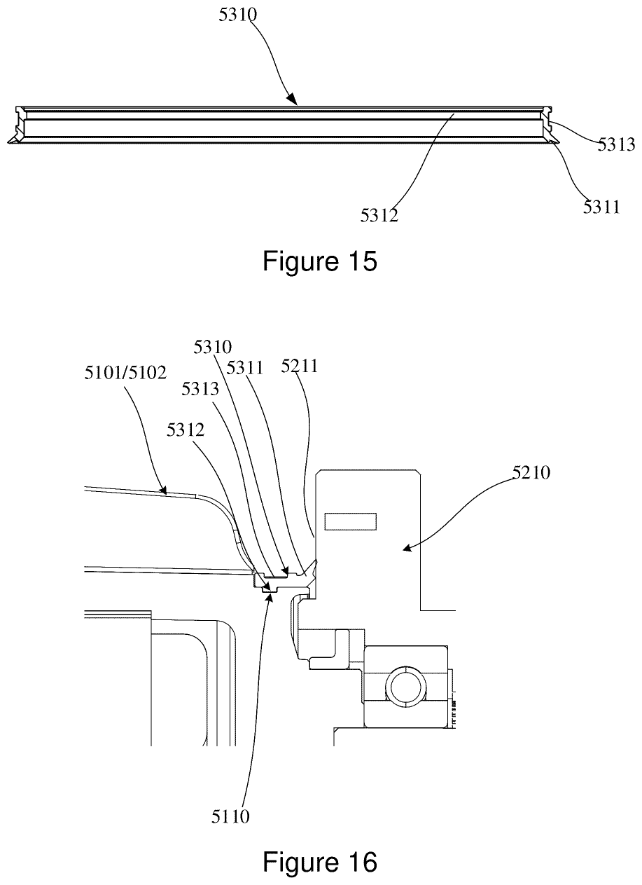

Please refer to FIG. 15 and FIG. 16. In this embodiment of the disclosure, the end of the first elastic structure 5311 is set to a double-lip structure. When the double-lip structure at the end of the first elastic structure 5311 is interference abutted on the outer tooth ring end surface 5211 of the first reducer 5201, the double-lip structure may form two rings of sealing structures at different radial positions on the outer tooth ring end surface 5211, whereby the two rings of the sealing structure can form two block parts at a connection position of the first driving motor 5101 and the first reducer 5201, so as to enhance a sealing effect between the first sealing ring 5310 and the first reducer 5201.

Please refer to FIG. 15 and FIG. 16. In an embodiment of the disclosure, an inner ring of the first sealing ring 5310 is provided with a second protrusion 5312. The second protrusion 5312 is arranged along a circumferential inner edge of the first sealing ring 5310, and the first driving motor 5101 is provided with a first groove 5110 matched with the second protrusion 5312 on a circumferential outer edge of a housing at a side of the first reducer 5201. When the first sealing ring 5310 is sleeved on the housing of the first driving motor 5101, the second protrusion 5312 on the inner ring of the first sealing ring 5310 is clamped and fixed in the first groove 5110 around an outer edge of the housing of the first driving motor 5101. The housing of the first driving motor 5101 clamps the second protrusion 5312 with elastic deformation characteristics in the first groove 5110, so that the first sealing ring 5310 is fixed on the housing of the first driving motor 5101.

Please refer to FIG. 14. In an embodiment of the disclosure, an outer ring of the first sealing ring 5310 is further provided with a clamping hood 5500. The clamping hood 5500 is sleeved on the outer ring of the first sealing ring 5310, and the clamping hood 5500 limits the first sealing ring 5310 in the circumferential direction, so that the first sealing ring 5310 is sleeved on the housing of the first driving motor 5101. Wherein, a circumferential surface of the outer ring of the first sealing ring 5310 is provided with a second groove 5313 concave inward. A shape of the second groove 5313 is matched with the clamping hood 5500, and a flange extending inward is arranged at two ends at a top of a groove body. The clamping hood 5500 is embedded in the second groove 5313 along the circumferential direction of the first sealing ring 5310, and is blocked and fixed in the groove body by the top flange of the second groove 5313.

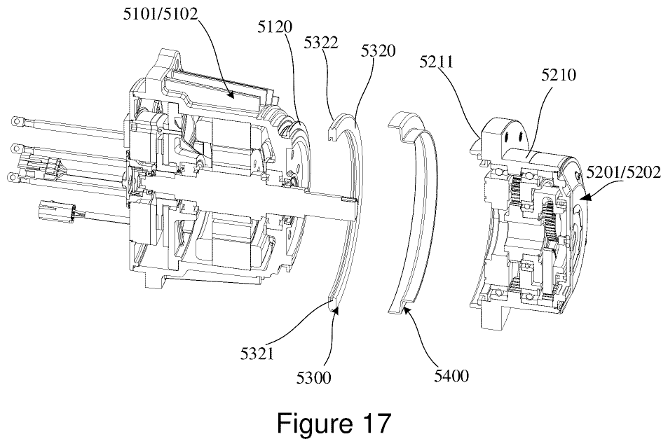

Please refer to FIG. 17 through FIG. 20. In some embodiments, the first driving motor 5101 is coaxially arranged with the first reducer 5201, and is fixed and connected with the first reducer 5201 through the bolt. The sealing structure between the first driving motor 5101 and the first reducer 5201 is provided with the first sealing component 5300 and the second sealing component 5400 matched with each other. Wherein, the first sealing component 5300 is coaxially sleeved on the housing of one side of the first driving motor 5101 towards the first reducer 5201, and the first sealing component 5300 is fixedly arranged on the circumferential periphery of the housing of the first driving motor 5101. The first sealing component 5300 does not rotate axially on the housing of the first driving motor 5101. The second sealing component 5400 is coaxially arranged on one side of the first reducer 5201 towards the first driving motor 5101, and the first sealing component 5300 and the second sealing component 5400 are arranged relative to each other at a radial plane at the connection position between the first driving motor 5101 and the first reducer 5201, and matched with each other to form the seal.

Please refer to FIG. 17 through FIG. 20. In an embodiment of the disclosure, the first sealing component 5300 is a second sealing ring 5320. The second sealing ring 5320 is sleeved and fixed on the peripheral of the housing of the first driving motor 5101, and an outer ring of the second sealing ring 5320 is provided with a second elastic structure 5322 along the an outer edge of the circumferential direction. The second elastic structure 5322 extends in a ring along the circumferential direction of the outer ring of the second sealing ring 5320. The second sealing component 5400 is an oil sealing 5410. The oil sealing 5410 is provided with a plane, and this plane extends along the radial direction. The oil sealing 5410 is coaxially connected with the outer tooth ring 5210 of the first reducer 5201 on a first side of the radial plane, and the oil sealing 5410 is provided with a lip edge 5412 on a second side of the radial plane. The lip edge 5412 is arranged along a circumferential outer edge of the radial plane of the oil sealing 5410, and the lip edge 5412 extends to a side of the first driving motor 5101 at an outer edge of the circumferential direction of the oil sealing 5410. When the first reducer 5201 is coaxially assembled to the first driving motor 5101, the second sealing ring 5320 is sleeved on the housing of the first driving motor 5101 towards one side of the first reducer 5201. One end of the oil sealing 5410 is coaxially connected with the outer tooth ring 5210 of the first reducer 5201, the radial plane on the oil sealing 5410 is arranged opposite to one side of the second sealing ring 5320 towards the first reducer 5201, and the lip edge 5412 arranged along the outer edge of the circumferential direction of the oil sealing 5410 is located on a circumferential outward side of the second sealing ring 5320. The second elastic structure 5322 protruding on the outer ring of the second sealing ring 5320 is interference abutted with an inner wall of the lip edge 5412 of the oil sealing 5410. An end of the second elastic structure 5322 conflicts and fits with the inner wall of the lip edge 5412 along a circumferential plane. And when the outer tooth ring 5210 rotates along the axial direction, the external foreign matter is prevented from entering from a conflicting position by a friction and matching with the inner wall of the lip edge 5412 of the oil sealing 5410 along the circumferential direction, so as to form the sealing structure that does not affect the axial rotation of the first reducer 5201.

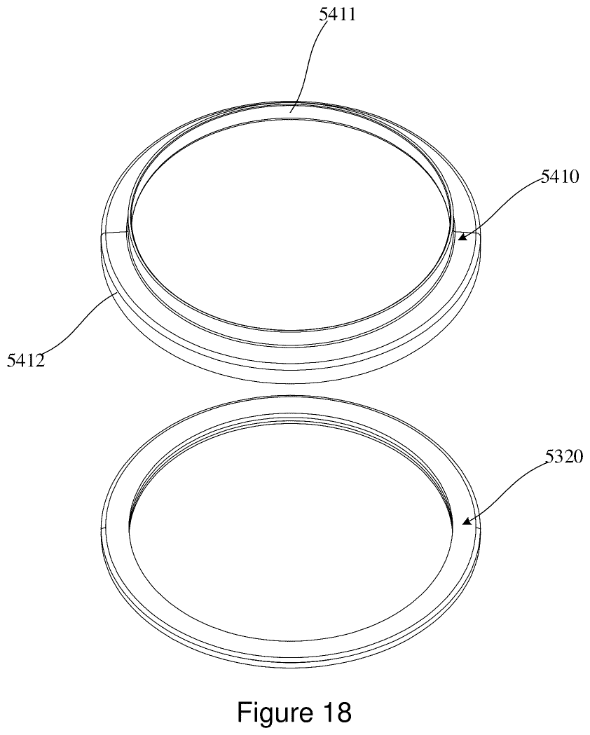

Please refer to FIG. 18 through FIG. 20. In this embodiment, the sealing structure utilizes the matching between the second sealing ring 5320 and the oil sealing 5410 in the radial plane and the circumferential plane, and effectively utilizes a sealing area of a matching between the first sealing component 5300 and the second sealing component 5400 increased by a small gap distance at the connection position of the first driving motor 5101 and the first reducer 5201, so that the sealing effect of the sealing structure is improved.

Please refer to FIG. 17 and FIG. 20. In an embodiment of the disclosure, one end of the oil sealing 5410 connected with the first reducer 5201 is provided with a tightening steel ring 5411. The tightening steel ring 5411 is arranged along a circumferential inner edge of the radial plane of the oil sealing 5410, the tightening steel ring 5411 extends outward along the axial direction, and a size of the tightening steel ring 5411 matches the outer tooth ring 5210 of the first reducer 5201. The tightening steel ring 5411 of the oil sealing 5410 is sleeved on the outer tooth ring 5210 of the first reducer 5201, for example, sleeved on an outer side of the outer tooth ring 5210. The oil sealing 5410 is firmly connected with the first reducer 5201 through an interference fit between the tightening steel ring 5411 and the outer tooth ring 5210.

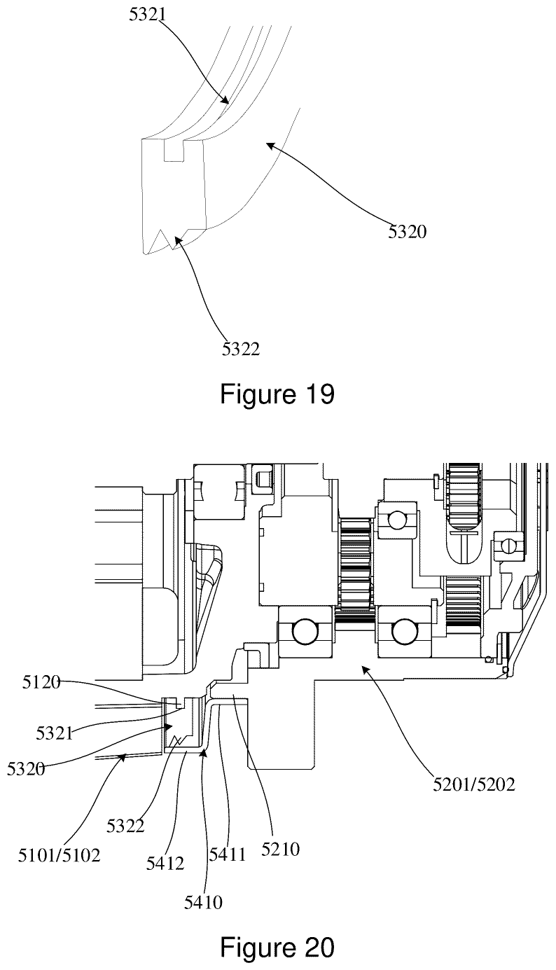

Please refer to FIG. 19 and FIG. 20. In this embodiment of the disclosure, the end of the second elastic structure 5322 is set to the double-lip structure. When the double-lip structure at the end of the second elastic structure 5322 is interference abutted on the inner wall of the lip edge 5412 of the oil sealing 5410, the double-lip structure may form two rings of sealing structures at different axial positions on the inner wall of the lip edge 5412. The two rings of the sealing structure can form two block parts at a circumferential surface of the second sealing ring 5320 opposite to the oil sealing 5410, so as to enhance a sealing effect between the second sealing ring 5320 and the oil sealing 5410.

Please refer to FIG. 19 and FIG. 20. In an embodiment of the disclosure, an inner ring of the second sealing ring 5320 is provided with a third groove 5321. The third groove 5321 is arranged along a circumferential inner edge of the second sealing ring 5320, and the first driving motor 5101 is provided with a third protrusion 5120 matched with the third groove 5321 on the circumferential outer edge of the housing at the side of the first reducer 5201. When the second sealing ring 5320 is sleeved on the housing of the first driving motor 5101, the third protrusion 5120 on the outer edge of the circumferential direction of the housing of the first driving motor 5101 is clamped and fixed in the third groove 5321 on the inner ring of the second sealing ring 5320. The first driving motor 5101 utilizes an interference fit between the third protrusion 5120 and the third groove 5321 to fix the second sealing ring 5320 on the housing of the first driving motor 5101.

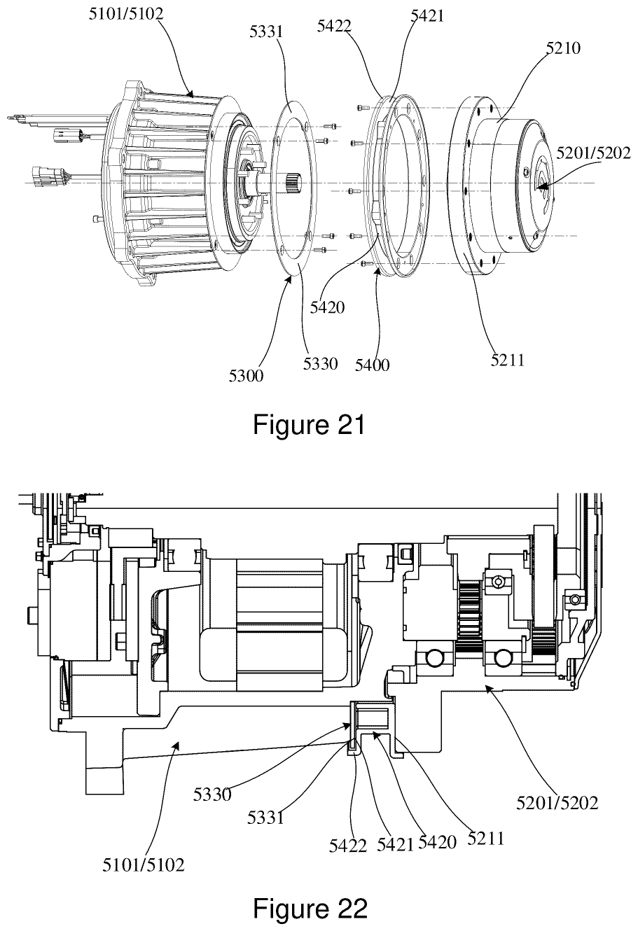

Please refer to FIG. 21 through FIG. 24. In some embodiments, the first sealing component 5300 is provided with a first deck surface 5331, and the second sealing component 5400 is provided with a second deck surface 5421. The first deck surface 5331 of the first sealing component 5300 and the second deck surface 5421 of the second sealing component 5400 are relatively arranged along the radial plane. A gap is maintained between the first deck surface 5331 and the second deck surface 5421, and the first sealing component 5300 and the second sealing component 5400 utilize the gap between the first deck surface 5331 and the second deck surface 5421 to prevent an entry of external foreign matters, so as to form the sealing structure that does not affect the axial rotation of the first reducer 5201.

Wherein, a gap distance between the first deck surface 5331 and the second deck surface 5421 is from 1 mm to 3 mm, and this gap distance may be 1 mm, 2 mm or 3 mm for example.

Please refer to FIG. 21 and FIG. 22. In an embodiment of the disclosure, the first sealing component 5300 is an end surface pressing plate 5330. One surface of the end surface pressing plate 5330 towards the first reducer 5201 is set to the first deck surface 5331. The end surface pressing plate 5330 is sleeved on one side of the housing of the first driving motor 5101 towards the first reducer 5201, and the end surface pressing plate 5330 is sleeved in a circumferential periphery of the housing of the first driving motor 5101, and is fixedly connected with the housing of the first driving motor 5101 by the bolts. The second sealing component 5400 is a rotating frame 5420, and the rotating frame 5420 is fixedly connected with the outer tooth ring end surface 5211 of the first reducer 5201 through the bolts. The second deck surface 5421 of the rotating frame 5420 and the first deck surface 5331 of the first sealing component 5300 are arranged relative to each other along the radial plane, and are matched with each other to form the seal.

Please refer to FIG. 21 and FIG. 22. In an embodiment of the disclosure, the rotating frame 5420 is provided with a first flange 5422 on the second deck surface 5421, and the first flange 5422 on the second deck surface 5421 is arranged along the outer edge of the circumferential direction of the first deck surface 5331 and extends to one side of the first driving motor 5101. When the first driving motor 5101 and the first reducer 5201 are axially connected, the first deck surface 5331 of the end surface pressing plate 5330 is arranged opposite to the second deck surface 5421 of the rotating frame 5420. The first flange 5422 arranged on the second deck surface 5421 surrounds a periphery of the end surface pressing plate 5330 along the circumferential direction, and the outer edge of circumferential direction of the end surface pressing plate 5330 is relatively matched with the first flange 5422 on the circumferential plane to form the seal. In an embodiment, between the end surface pressing plate 5330 and the rotating frame 5420, in addition to utilizing the relative matching of the first deck surface 5331 and the second deck surface 5421 to form the sealing structure on the radial surface, the sealing structure on the circumferential surface is also formed through a relative matching of an outer edge of the end surface pressing plate 5330 and the first flange 5422 on the rotating frame 5420. The sealing structure of the circumferential surface can produce an outward centrifugal force at a gap between the end surface pressing plate 5330 and the first flange 5422 to throw out the foreign matter entering the gap when the rotating frame 5420 rotates relative to the end surface pressing plate 5330 with the first reducer 5201, so as to achieve an efficient sealing.

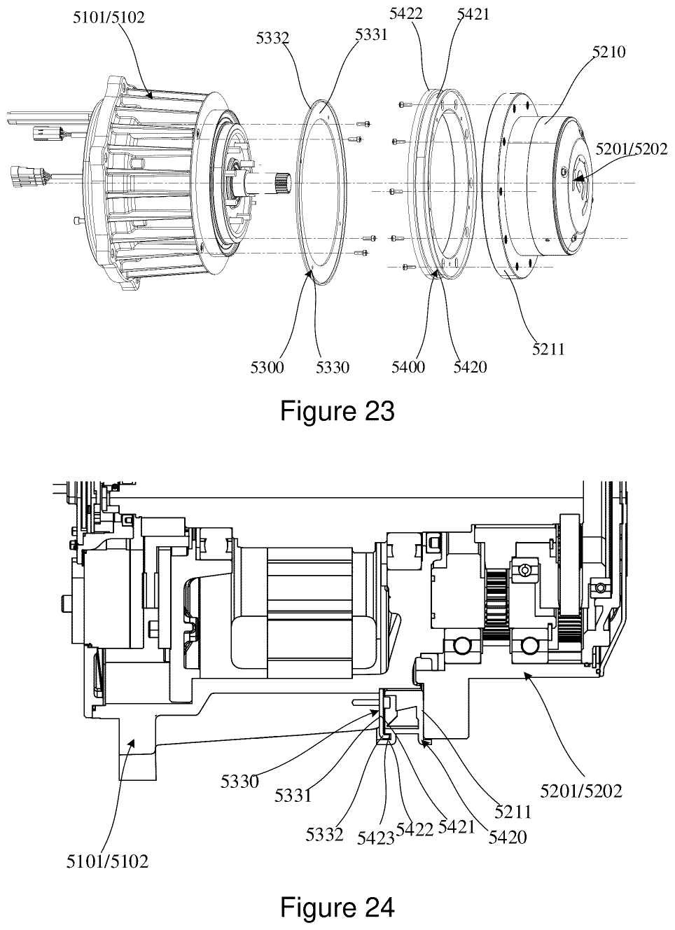

Further, please refer to FIG. 23 and FIG. 24. In an embodiment of the disclosure, the end surface pressing plate 5330 is provided with a second flange 5332 on the first deck surface 5331, and the second flange 5332 on the first deck surface 5331 is arranged along an inner edge of the circumferential direction of the second deck surface 5421 and extends to one side of the first reducer 5201. The second deck surface 5421 of the rotating frame 5420 is provided with a sealing groove 5423 at a position corresponding to the second flange 5332. The sealing groove 5423 is arranged along the inner edge of the circumferential direction of the second deck surface 5421, and a shape of the sealing groove 5423 matches the second flange 5332. In an embodiment, an outer ring of the sealing groove 5423 is arranged at the first flange 5422 located at an outer edge of the second deck surface 5421, and an inner ring of the sealing groove 5423 is arranged at an inner edge of the second deck surface 5421.

Please refer to FIG. 24. When the first driving motor 5101 and the first reducer 5201 are axially connected, the first deck surface 5331 of the end surface pressing plate 5330 is arranged opposite to the second deck surface 5421 of the rotating frame 5420. The second flange 5332 arranged on the first deck surface 5331 is embedded in the sealing groove 5423 arranged on the second deck surface 5421, and in the sealing groove 5423, the second flange 5332 is respectively matched with inner walls of both sides of the sealing groove 5423 and a bottom of the groove to form the seal. Under a premise of not affecting the relative rotation of the first reducer 5201, the sealing structure increases a sealing length between the end surface pressing plate 5330 and the rotating frame 5420 on a plurality of radial and circumferential surfaces, which effectively improves the sealing effect of the sealing structure.

The calibration method of the garden tool of the disclosure pushes the operating mechanism of the wheels on two sides to the mechanical extremum position when correcting and calibrating the garden tool. If the extremum rotating speeds of the wheels on the two sides are not equal, the extremum rotating speeds of the wheels on the two sides are kept consistent by correcting a ratio of the output voltage of the angle sensor and the output rotating speed of the controller. The calibration method of the disclosure is simple, easy to operate and has a relatively fast calibration, achieving an effect of one-click deviation correction.

Furthermore, the disclosure establishes the controllers of the wheels on the two sides in the same communication network so that the controllers can recognize the wheel rotating speeds controlled by each other. By utilizing this feature, the disclosure only needs to associate the controllers of the wheels on the two sides of the garden tool on a production line so that they can recognize the rotating speeds of each other, thereby solving customer complaints about new vehicles running off track and a problem of old vehicles running off track.

Further, in the walking driving mechanism and the garden tool provided by the disclosure, the sealing structure is arranged at the connection of the driving motor and the reducer, and the sealing structure is formed by the radial surface or the circumferential surface of a connection position of the driving motor and the reducer to form a sealing fit, so that a sealing length of the sealing structure is effectively increased by utilizing a small gap at the connection position of the driving motor and the reducer, and then the foreign body impurities are prevented from entering the rotating gap between the reducer and the driving motor while not affecting the axial rotation of the reducer, so as to achieve an effective sealing effect.

In the garden tool 10 provided by the disclosure, the sealing structure is arranged at the connection of the driving motor and the reducer, and the sealing structure is formed by the radial surface or the circumferential surface of a connection position of the driving motor and the reducer to form a sealing fit, so that a sealing length of the sealing structure is effectively increased by utilizing a small gap at the connection position of the driving motor and the reducer, and then the foreign body impurities are prevented from entering the rotating gap between the reducer and the driving motor while not affecting the axial rotation of the reducer, so as to achieve an effective sealing effect. Therefore, the disclosure effectively overcomes some practical problems in the prior art, thereby having high utilization value and use significance.

The above embodiments only illustrate principles and effects of the disclosure, but are not intended to limit the disclosure. Anyone familiar with this technology may modify or change the above embodiments without departing from a scope of the disclosure. Therefore, all equivalent modifications or changes made by those with ordinary knowledge in the technical field without departing from the technical ideas disclosed in the disclosure shall still be covered by the claims of the disclosure.

What is claimed is:

1. A calibration method of a garden tool, the garden tool comprising a control assembly, a first wheel, a second wheel and an operating mechanism, wherein,
the operating mechanism is provided with a detection device to detect a displacement of the operating mechanism;
the calibration method at least comprises:
receiving a deviation correction command;
comparing an extremum rotating speed of the first wheel with an extremum rotating speed of the second wheel, wherein the extremum rotating speed of the first or second wheel is a wheel rotating speed when the operating mechanism is pushed to a mechanical extremum position; and
correcting a relationship between an output signal of the detection device and an output rotating speed of the control assembly to enable the extremum rotating speed of the first wheel to be the same as the extremum rotating speed of the second wheel when there is a difference between the extremum rotating speed of the first wheel and the extremum rotating speed of the second wheel.

2. The calibration method according to claim 1, wherein, the control assembly comprises a first controller and a second controller, the first controller is configured to control a rotating speed of the first wheel, the second controller is configured to control a rotating speed of the second wheel, the first controller and the second controller are established in a same communication network, and the first controller and the second controller are configured to recognize output rotating speeds of each other.

3. The calibration method according to claim 2, wherein, the control assembly further comprises an operation panel, a deviation correction button is arranged on the operation panel, the deviation correction command is sent to the first controller and the second controller through the deviation correction button, and a manner of sending the deviation correction command comprises an IO command or a communication command.

4. The calibration method according to claim 1, wherein, comparing the extremum rotating speed of the first wheel with the extremum rotating speed of the second wheel comprises:
determining whether the extremum rotating speed of the first wheel and the extremum rotating speed of the second wheel are both greater than zero;
comparing whether there is a difference between the extremum rotating speed of the first wheel and the extremum rotating speed of the second wheel when the extremum rotating speed of the first wheel and the extremum rotating speed of the second wheel are both greater than zero.

5. The calibration method according to claim 1, wherein, the garden tool comprises two operating mechanisms to control the first wheel and the second wheel respectively, each operating mechanism comprises an operating installation base, an operating handle and an operating rod, the operating installation base is fixedly installed on a vehicle frame of the garden tool, the operating rod is rotatably installed in the operating installation base along a first direction, and the operating handle is arranged above the operating rod and is rotatably connected with the operating rod along a second direction.

6. The calibration method according to claim 5, wherein, the detection device comprises an angle sensor, the angle sensor is installed on the operating rod on a corresponding side, a rotating shaft of the angle sensor rotates synchronously with the operating rod, an output voltage of the angle sensor is linearly related to an opening degree of the operating handle, and the output voltage of the angle sensor is linearly related to a corresponding wheel rotating speed output by the control assembly.

7. The calibration method according to claim 6, wherein, the control assembly comprises a first controller and a second controller, the first controller is configured to control a rotating speed of the first wheel, the second controller is configured to control a rotating speed of the second wheel,
when there is a difference between the extremum rotating speed of the first wheel and the extremum rotating speed of the second wheel, correcting a relationship between the output signal of the detection device and a corresponding wheel rotating speed output by the control assembly comprises:
when the extremum rotating speed of the first wheel is greater than the extremum rotating speed of the second wheel, the second controller not responding; and
the first controller locking a current voltage of the angle sensor on a side of the first wheel and the extremum rotating speed of the second wheel, and correcting a proportional relationship between the voltage of the angle sensor on the side of the first wheel and the rotating speed output by the first controller based on the current voltage of the angle sensor on the side of the first wheel and the extremum rotating speed of the second wheel, so as to keep the extremum rotating speed of the first wheel consistent with the extremum rotating speed of the second wheel.

8. The calibration method according to claim 6, wherein, when the extremum rotating speed of the first wheel is less than the extremum rotating speed of the second wheel, the first controller does not respond, the second controller locks a current voltage of the angle sensor on a side of the second wheel and the extremum rotating speed of the first wheel, and corrects a proportional relationship between the voltage of the angle sensor on the side of the second wheel and the rotating speed output by the second controller based on the current voltage of the angle sensor on the side of the second wheel and the extremum rotating speed of the first wheel, so as to keep the extremum rotating speed of the second wheel consistent with the extremum rotating speed of the first wheel.

9. The calibration method according to claim 6, wherein, the operating mechanism further comprises a reset assembly, the reset assembly comprises a spring base and a compression spring arranged in the spring base, the spring base is mounted at a bottom of the operating installation base, a first end of the compression spring is connected with the spring base, a second end of the compression spring is connected with the operating rod, and two sides of the operating rod are respectively provided with a first protrusion matched with the compression spring.

10. The calibration method according to claim 6, wherein, the operating mechanism further comprises a limiting plate, the limiting plate is arranged on the operating installation base and is provided with a limiting hole on the limiting plate that matches a rotation of the operating handle.

11. The calibration method according to claim 10, wherein, the limiting hole includes a first orientation hole and a second orientation hole, the first orientation hole is adapted to a rotating amplitude of the operating handle in the first direction, the second orientation hole is communicated with the first orientation hole, and the second orientation hole is adapted to a rotating amplitude of the operating handle in the second direction.

12. The calibration method according to claim 2, wherein, the garden tool further comprises a first driving motor and a second driving motor, the first driving motor is configured to drive the first wheel to rotate and is electrically connected with the first controller, the second driving motor is configured to drive the second wheel to rotate and is electrically connected with the second controller.

13. A garden tool, comprising:
a first wheel, the first wheel arranged on a first side of a vehicle frame of the garden tool;
a second wheel, the second wheel arranged on a second side of the vehicle frame of the garden tool;
a control assembly, the control assembly configured to control rotating speeds of the first wheel and the second wheel respectively; and
an operating mechanism, the operating mechanism configured to adjust the rotating speeds and/or steerings of the first wheel and the second wheel, and provided with a detection device to detect a displacement of the operating mechanism, and the detection device electrically connected with the control assembly; wherein
the control assembly is configured to receive a deviation correction command, an extremum rotating speed of the first wheel is compared with an extremum rotating speed of the second wheel, when the garden tool is calibrated for a deviation correction, wherein, the extremum rotating speed of the first wheel or second wheel is a wheel rotating speed when the operating mechanism is pushed to a mechanical extremum position; and
a relationship between an output signal of the detection device and an output rotating speed of a corresponding wheel of the control assembly is corrected to enable the extremum rotating speed of the first wheel to be the same as the extremum rotating speed of the second wheel when there is a difference between the extremum rotating speed of the first wheel and the extremum rotating speed of the second wheel.

14. The garden tool according to claim 13, wherein, the control assembly comprises a first controller and a second controller, the first controller is configured to control a driving device of the first wheel, the second controller is configured to control a driving device of the second wheel, the first controller and the second controller are established in a same communication network, and the first controller and the second controller are configured to recognize output rotating speeds of each other.

15. The garden tool according to claim 14, wherein, the first wheel and the second wheel are driven by corresponding driving motors and reducers respectively, and sealing structures are arranged at a connection position between the driving motors and the reducers.

16. The garden tool according to claim 15, wherein, the sealing structure comprises a first sealing component, and the first sealing component is coaxially sleeved on the driving motor and/or the reducer.

17. The garden tool according to claim 16, wherein, the first sealing component is a first sealing ring, the first sealing ring is provided with a first elastic structure, and the first elastic structure is arranged on one surface of the first sealing ring facing the reducer along a circumferential direction, abutted against an end face of the reducer in an interference fit, and forms a sealing with the end face through a friction matching.

18. The garden tool according to claim 16, wherein, the sealing structure further comprises a second sealing component, the second sealing component is coaxially arranged on the reducer, and a radial plane of the second sealing component at a connection position is arranged relative to the first sealing component.

19. The garden tool according to claim 18, wherein, the first sealing component is a second sealing ring, the second sealing ring is provided with a second elastic structure along an outer edge along the circumferential direction, the second sealing component is provided with a lip edge along the circumferential direction, the lip edge is located at a circumferential outward side of the second sealing ring, and the second elastic structure is abutted against an inner wall of the lip edge along the circumferential direction in an interference fit, and is matched with the lip edge to form a seal through a friction matching.

20. A mower, comprising:
a first wheel, the first wheel arranged on a first side of a vehicle frame of the mower;
a second wheel, the second wheel arranged on a second side of the vehicle frame of the mower;
a control assembly, the control assembly configured to control rotating speeds of the first wheel and the second wheel respectively; and
an operating mechanism, the operating mechanism configured to adjust the rotating speeds and/or steerings of the first wheel and the second wheel, provided with a detection device to detect a displacement of the operating mechanism, and the detection device electrically connected with the control assembly; wherein
the control assembly is configured to receive a deviation correction command, compare an extremum rotating speed of the first wheel with an extremum rotating speed of the second wheel when the mower is calibrated for a deviation correction, wherein, the extremum rotating speed of the first wheel or second wheel is a wheel rotating speed when the operating mechanism is pushed to a mechanical extremum position; and
a relationship between an output signal of the detection device and an output rotating speed of a corresponding wheel of the control assembly is corrected to enable the extremum rotating speed of the first wheel to be the same as the extremum rotating speed of the second wheel when there is a difference between the extremum rotating speed of the first wheel and the extremum rotating speed of the second wheel.
